(19) United States
(12) Patent Application Publication
(10) Pub. No.: US 2020/0326065 A1
(43) Pub. Date: Oct. 15, 2020

(54) Illuminated weather resistant rug

(71) Applicants: Christopher Michael Bergman, Commerce, MI (US); Christie Marie Asam, Waterford, MI (US)

(72) Inventors: Christopher Michael Bergman, Commerce, MI (US); Christie Marie Asam, Waterford, MI (US)

(21) Appl. No.: 16/383,974

(22) Filed: Apr. 15, 2019

(51) Int. Cl. F21V 33/00; H02S 40/38; F21S 9/03; F21S 4/00; F21V 23/04; A47G 27/02

(52) U.S. Cl. CPC F21V 33/0024; H02S 40/38; F21S 9/032; F21Y 2115/10; F21V 23/0464; A47G 27/02; F21S 4/00

(57) ABSTRACT

An illuminated weather resistant rug for ground or floor covering for decorative or practical purposes suitable for indoor and outdoor use. The rug is illuminated by LED lights that are strung within a waterproof casing and attached to the rug within the hem or interwoven as the weft or warp of the rug. Power for the LEDS is supplied by solar, solar with battery, battery, AC plug, DC plug, 12-volt, or USB. Power source can be a direct or detachable connection to the rug. Power to the LEDS can be modulated by manual switch, automated switch, timer, photovoltaic switch or electrical controller for intensity, sequencing, coloring or pattern of illumination. Primary rug material includes any material that is weather resistant and durable enough for foot traffic or static loads such as patio furniture.

### BACKROUND OF THE INVENTION

### 1. Field of the Invention

The present invention generally relates to rugs, specifically an illuminated rug that is weather resistant and suitable for indoor and outdoor use.

Rug is defined by “merriam-webster.com” as “a piece of thick heavy fabric that usually has a nap or pile and is used as a floor covering.” Rug is defined by “dictionary.com” as “a thick fabric for covering part of a floor, often woven of wool and often having an oblong shape with a border design.” The use of the term rug is not meant to limit the size, shape, or use of the device more so to describe its portability, utility, and adorning potential. Further the term rug, mat, carpet, or throw can be used to describe the device without modifying the scope of the invention.

A rug, as used herein, is typically placed on an existing floor covering to protect the under surface or as an ornamental piece for decoration. Further the weather resistant construction of this rug makes it ideal for outdoor use to protect outdoor surfaces (pavers, stone, concrete, wood) such as porches, patios, decks, grass lawns or campsites. The illumination provided by the LEDS allows for added safety when used at night to prevent tripping on the edge of the rug and lighting of pathways. Further, the LEDS provide the added benefit and aesthetic appeal of light, patterns and color to home, yard, or camping decor. Patterns and colors could be used to display images, signage, sports teams, etc.

Other illuminated floor surfaces exist within the market. This invention differentiates from the others by way of intended use and construction. The other inventions consist of separate layers for traffic and electrical component that are detachable and exclusive. This Invention integrates the electrical components within the construction. Further the light source for the other inventions is from fiberoptic or diffused LEDS. This invention utilizes direct light from multiple LEDS within a strung array that can be woven into the rug as the wrap or weft, or attached to the rug within the hem. Other inventions depend on pressure sensors, motion sensors, or manual switches to activate the light source. This device is activated by photovoltaic sensor, manual switch, direct plug in, timer, or controller. This device is able to be directly wired to power source or use detachable waterproof connections to adapt to which power source the user desires.

### 2. Description of Prior Art

LED illuminated devices are generally known. The following patents describe illuminated devices. The following cited patents are not an admission of any relevance to the invention rather to demonstrate an understanding of the current state of the art pertaining to illuminated floor coverings.

U.S. Pat. No. 7,670,026 to Hawkins; Victor Jonathan that filed October 2008;

U.S. Pat. No. 8,444,294 to Hawkins; Victor Jonathan that filed January 2010;

U.S. Pat. No. 7,358,861 to Blum et al., that issued April 2008;

U.S. Pat. No. 5,848,830 to Castle et al., that issued December 1998;

U.S. Pat. No. 4,737,764 to Harrison, that issued April 1988.

The structural arrangements of the above described devices at first appear to have similarities with the present invention, yet they differ in material respects. The differences, as described in more detail hereinafter, are essential for the effective use of the invention and provide distinct advantages that are not available in prior devices.

### OBJECTS AND SUMMARY OF THE INVENTION

It is an object of the present invention to provide an illuminated weather resistant floor covering that is suitable for indoor and outdoor use.

It is an object of the present invention to provide an illuminated weather resistant floor covering that serves as a protective layer for surfaces below the rug.

It is an object of the present invention to provide an illuminated weather resistant floor covering that serves as a barrier from unfinished surfaces (i.e., dirt, sand, stone, grass, lawn, campsite, etc.) for the user.

It is an object of the present invention to provide an illuminated weather resistant floor covering that serves as a decorative or ornamental piece.

It is an object of the present invention to provide an illuminated weather resistant floor covering that serves as a safety device by illuminating a dark indoor or outdoor space.

It is an object of the present invention to provide an illuminated weather resistant floor covering that can be powered via standard AC or DC connection.

It is an object of the present invention to provide an illuminated weather resistant floor covering that can be powered via battery pack (rechargeable or replaceable cells).

It is an object of the present invention to provide an illuminated weather resistant floor covering that can be powered via solar cells with rechargeable battery pack.

It is an object of the present invention to provide an illuminated weather resistant floor covering that may be directly wired to a power source.

It is an object of the present invention to provide an illuminated weather resistant floor covering that may have a weather resistant detachable wired connection to a variety of power sources (AC, DC, Battery, Solar, etc.)

It is an object of the present invention to provide an illuminated weather resistant floor covering that may have a switch be it mechanical, timer, or photovoltaic.

It is an object of the present invention to provide an illuminated weather resistant floor covering that may be customized to any desired size or shape.

It is an object of the present invention to provide an illuminated weather resistant floor covering that may be customized to any desired color, pattern, image, or text.

It is an object of the present invention to provide an illuminated weather resistant floor covering that may utilize an electronic or digital control to animate or sequence the LEDs.

It is an object of the present invention to provide an illuminated weather resistant floor covering that may have the LEDS strung in the hem, weft or warp of the rug; singularly or in any combination.

### BRIEF DESCRIPTION OF THE DRAWINGS

FIG. 1: is a view of the rug with three areas that are zoomed in to show greater details of the warp, weft, and hem. As well as the power sources. Standard items within the drawing refer to items that are of the material of choice for manufacture and may be of any color or composition to meet the desired use.

FIG. 1A: is a string of LEDS where they have replaced a single warp of the rug, however any number of warps may be strung LEDS.

FIG. 1B: is a standard warp.

FIG. 1C: is a string of LEDS where the have replaced a single weft of the rug, however any number of wefts may be strung LEDS.

FIG. 1D: is a standard weft.

FIG. 1E: is a section of transparent hem that is used to attach the LEDS to the border of the rug. The material may be completely transparent or translucent, solid or perforated.

FIG. 1F: is wire to carry electricity to the LEDS within a string.

FIG. 1G: is a single LED within a series. When attached to an electrical controller may be turned on, off, or dimmed individually. Further with an RGB LED can be modulated to change color.

FIG. 1H: is the water tight transparent/translucent casing containing the LEDS, wires, and circuitry.

FIG. 1I: is the primary hem to contain the edge binding of the rug. Alternatively, the hem of FIG E can be used exclusively.

FIG. 1J: two stitches are shown to hold the hem in FIG. 1E and FIG. 1I. Any number or pattern of stitching may be used to meet desired look and durability. Further, bonding may be accomplished with thermal bonding or an adhesive.

FIG. 1K: is an LED, any number may be used.

FIG. 1L: is the surface of the rug. The rug may be reversed as the LEDS are integrated within the warp, weft or hem and are visible from either side.

FIG. 1M: power cable to the rug. May be directly connected to power source or as shown in this diagram with a detachable connection.

FIG. 1N: is a lockable waterproof power attachment unit on the rug side.

FIG. 1O: is a photovoltaic light sensor.

FIG. 1P: is switch for on/off/timer/program.

FIG. 1Q: is a solar cell array.

FIG. 1R: is a battery pack. The battery pack may have replaceable or rechargeable batteries (removeable or fixed). The battery pack may alternative or concurrently house an electrical controller.

FIG. 1S: is a lockable waterproof power attachment unit of the power source side.

FIG. 1T: is a power plug that may be for AC, DC, USB, USB-C, 12-volt, or any other standard electrical connection.

### DETAILED DESCRIPTION OF THE INVENTION

When necessary references to the drawing may be made. This is an illuminated weather resistant rug. It shall be constructed of materials that are moisture, cold, heat, ultraviolet, and wear resistant. The design should be durable enough to withstand foot traffic as well as support outdoor furniture such as picnic tables, chairs, patio furniture, or other outdoor and camping accessories.

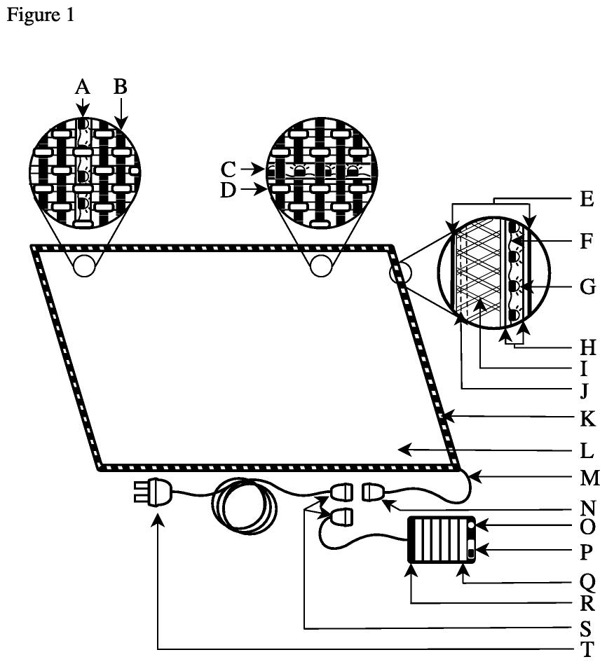

Illumination shall be provided by LEDS. The LEDS shall be strung in a row (FIG. 1, G, F) with circuitry (FIG. 1R) to allow for control of on, off (FIG. 1O, P), dimming, color, and sequencing. The LED string shall be surrounded by a waterproof casing (FIG. 1H). The LEDS may be permanently attached to the rug within a transparent/translucent, solid or perforated hem (FIG. 1E), or woven within the rug as a component of or entirely as the warp (FIG. 1A) or warp (FIG. 1C). Any combination of attachment shall serve the intent of this invention.

Power for the LEDS is by any of the following exclusively or collectively: solar, solar with battery, battery, AC plug, DC plug, 12-volt car/RV adapt, or USB. Power source can be a direct or detachable connection to the rug. Power to the LEDS can be modulated by manual switch, automated switch, timer, photovoltaic switch or electrical controller for intensity, sequencing, coloring or pattern of illumination.

Modification of: material color, material pattern, thread count, LED color, LED pattern, LED count, LED configuration, LED luminescence, overall patter, trade marked images, logos, names, text, or the attached of accessories (straps, hooks, loops, etc.) does not change the essence of this invention. The invention has been shown, described, and illustrated in substantial detail with reference to the presently preferred embodiment. It will be understood by those skilled in this art that other and further changes and modifications may be made without departing from the spirit and scope of the invention which is defined by the claims appended hereto.

That which is claimed:

1. A weather resistant rug that is illuminated by light emitting diodes LEDS

2. The method of claim 1; wherein the LEDS are arranged as a strip, string or rope and sealed in a transparent waterproof casing. Here forth an array of LEDS in a strip, string or rope shall be referred to as LEDS

3. The method of claim 1; wherein the LEDS are permanently attached to the rug

4. The method of claim 3; wherein the LEDS are attached to the rug at the border by way of containment within a transparent or translucent hem.

5. The method of claim 3; wherein the LEDS are interwoven within or as a component of the weft of the rug.

6. The method of claim 3; wherein the LEDS are interwoven within or as a component of the warp of the rug.

7. The method of claim 1; wherein the weather resistance of the rug is derived from the base materials used in its construction including structural and cosmetic components.

8. The method of claim 1; wherein the electricity to power the LEDS is derived from an external power source.

9. The method of claim 8; wherein the rug is attached directly to the external power source via permanent wired connection to: standard AC plug and outlet connection, standard DC plug and outlet connection, solar panel with battery, rechargeable battery pack, or replaceable battery pack.

10. The method of claim 8; wherein the rug is attached indirectly to the external power source via a detachable interlocking watertight connection to: standard AC plug and outlet connection, standard DC plug and outlet connection, solar panel with battery, rechargeable battery pack, or replaceable battery pack.

11. The method of claim 1; wherein rug is illuminated immediately with no switch when attached to power source. The LEDS turn on when the rug is plugged into a standard AC or DC outlet, and off when unplugged.

12. The method of claim 1; wherein the rug is illuminated in a controlled manor via standard on/off switch. The LEDS turn on when the user turns the switch to on, and off when switched off.

13. The method of claim 1; wherein the rug is illuminated in a controlled manor via an automated timer. The LEDS turn on when activated and turn off at a user or present interval.

14. The method of claim 1; wherein the rug is illuminated in a controlled manor via a photovoltaic switch. The LEDS turn on when it is dark and turn off when it is light.

15. The method of claim 1; wherein the rug is illuminated via an electrical controller. The electrical controller has multiple function features that allow customization of illumination including but not limited to: dimming, sequencing, pattern illumination, timing, and colors.
